(19) United States
(12) Patent Application Publication
(10) Pub. No.: US 2015/0173390 A1
(43) Pub. Date: Jun. 25, 2015

(54) AROMATIZATION OF COFFEE

(71) Applicant: Koninklijke Douwe Egberts B.V., Utrecht (NL)

(72) Inventor: Angenita Dorothea van Loon-Post, Utrecht (NL)

(21) Appl. No.: 14/580,955

(22) Filed: Dec. 23, 2014

Related U.S. Application Data
(63) Continuation of application No. PCT/NL2013/050469, filed on Jun. 28, 2013.

(30) Foreign Application Priority Data
Jun. 29, 2012 (EP) 12174343.9

(51) Int. Cl. A23F 5/46; A23F 5/14

(52) U.S. Cl. CPC A23F 5/465; A23F 5/14

(57) ABSTRACT

Disclosed is a novel method of aromatizing coffee beans. The beans can be green or roasted, including ground beans, and are allowed to stand together with an aroma generating substance. The aroma generating substance preferably is a dry and solid natural substance, such as a cinnamon or vanilla stick, in whole or ground form. The invention also pertains to packages comprising both roasted coffee beans and an aroma generating substance.

### CROSS-REFERENCE TO RELATED APPLICATIONS

This application is a continuation of International Patent Application No. PCT/NL2013/050469, filed on Jun. 28, 2013, which claims the benefit of priority to European Application No. EP12174343.9, filed on Jun. 29, 2012, all of which are hereby incorporated herein by reference in their entireties.

### FIELD OF THE INVENTION

The invention pertains to a method for the aromatization of solid coffee, such as green or roasted beans, particularly with natural aroma generating substances. The invention also pertains to aromatized coffee beans, and roast and ground coffee as well as a flavored coffee extract resulting therefrom.

### BACKGROUND

Coffee is a well-known drink, generally prepared as a hot water or steam extract of roast and ground coffee beans. Although coffee is generally appreciated as a good-tasting drink, a demand exists to provide coffee with an aroma in addition to the aroma resulting from roast and ground coffee itself. Such coffees exist, e.g., flavorings have been used such as cinnamon, nutmeg, cardamom, vanilla, hazelnut, and orange blossom.

Generally, such aromatized coffees are prepared by processes involving flavoring liquids to come in contact with roast and ground coffee, or by including flavoring powders as an additive to roast and ground coffee. Frequently, the preparation of flavored coffee involves the addition of artificial flavors or aromas.

E.g., EP 674 839 describes roasted coffee containing an additional flavor component. The flavored coffee is prepared by the intensive mixing of roasted whole, broken or ground beans with an aromatizing substance. Particularly, adjuvants such as hydrocolloids are employed in order to improve the fixation of the aromas.

Other processes involve the use of impregnating liquids. E.g., in WO 2008/03054 coffee beans are infused with a liquid comprising water, a flavoring agent, a bridge initiator for acid salt bias, such as betaine, and an acid.

In EP 282 762 it is described to improve the organoleptic properties of roasted coffee, by increasing the acidity of green beans. The latter is done by impregnation with acid in aqueous solution. A similar process, wherein green beans are subjected to a solution of citric or tartaric acid, has been described in U.S. Pat. No. 1,821,551.

Various background references relate to coffee to which certain flavoring agents are added. These coffees are typically offered to a brewing equipment together with the flavoring agent, i.e., the resulting extract is from both coffee and the flavoring agent.

Thus, DE 195 40 014 discloses a powdered coffee mixture comprising roasted ground coffee and powdered spices, such as cocoa, cinnamon, vanilla, cloves, coriander, and cardamom. EP 1 609 370 relates to an alimentary product based on coffee and officinal herbs. FR 2 759 254 discloses a mixed drink having a coffee and fruit taste. Therein roast and ground coffee is mixed with colored and aromatized fruit powders. Further, as mentioned in Shankaracharya et al., Indian Food Packer, vol. 25(5), 1971, pages 28-36, a traditional Arab drink, viz. “Gahwa coffee,” is a blend of coffee and cardamom.

It is desired to provide aromatized coffee that can be brewed without the inclusion of additives. It is also desired to provide a process that does not require a substantial physical treatment of the coffee in addition to the normal steps of roasting and grinding.

### SUMMARY

In order to better address one or more of the foregoing desires the invention, in one aspect, presents a method for aromatizing coffee, comprising holding whole or ground coffee beans and at least one volatile aroma generating substance captured into an environment for an effective standing time, and removing said substance.

In another aspect, the invention provides aromatized coffee beans or grounds, obtainable by a method comprising holding coffee beans and at least one aroma-generating substance captured into an environment for an effective standing time, and removing said substance.

In yet another aspect, the invention resides in aromatized green coffee beans.

In a further aspect, the invention provides a package separably comprising whole or ground roasted coffee beans and an aroma generating substance.

In a still further aspect, wherein the package is a cartridge, the invention provides a cartridge comprising a compartment containing roasted coffee beans and a compartment containing an aroma generating substance, said compartment being connected so as to allow vapor communication from the compartment containing the aroma generating substance to the compartment containing the coffee beans.

In another aspect, the invention pertains to coffee obtainable by extraction from aromatized ground roasted coffee beans, wherein the coffee is aromatized with aroma from an aroma generating substance, and wherein the extraction takes place substantially in the absence of the aroma generating substance.

### DETAILED DESCRIPTION

In a broad sense, the invention is based on the judicious insight that the aromatization of coffee can take place without intimate physical contact between an aromatizing agent and the coffee. The presence of an aroma generating substance and whole or ground coffee beans, in the same environment results in volatiles, i.e. aromas, to be taken up by the coffee beans. The invention therewith differs fundamentally from various flavoured coffees described in the art, were expressly an extract is made (i.e. coffee is brewed) from a composition including not only the coffee, but also the flavoring agent. The invention, on the other hand, avoids brewing coffee from anything else than coffee (roast and ground) itself, but thereby provides the coffee with those aroma's that, as volatiles, have been generated by an aroma generating substance, such as a spice, and have been taken up by the coffee.

Hence, in the invention, the extraction (brewing) occurs substantially in the absence of the aroma generating substance. The process of aromatizing coffee according to the invention thereto also comprises the removal of the aroma generating substance. To this end, the aroma generating substance is held captured with the coffee, essentially in a removable way.

By “substantially absent” reference is made to the fact that, depending on the manner of initially capturing the coffee and the aroma generating substance, inadvertently a minor amount of the substance might not have been removed. Preferably the aroma generating substance is absent altogether, and preferably it is held captured with the coffee in a separate holder, such as a spice or tea bag, that facilitates removal.

The term “aroma generating substance” is to be understood in a broad sense, as including artificial aroma compounds, and extracted natural aromas. However, preferably, the aroma generating substance is not the synthesized or extracted aroma itself, but is a natural substance that generates volatile aromas. Such substances are particularly spices, herbs, fruits, or flowers. In the invention, the aroma generating substance thus preferably is a natural substance selected from the group consisting of spices, herbs, fruits, flowers, and mixtures thereof. Examples of such substances include, but are not limited to: clove, chamomile, ginger, lemongrass, cinnamon, licorice, anise, rosemary, thyme, vanilla, cacao, jasmine, lavender, and cardamom.

Preferably, these substances are presented in a solid form, and more preferably in their natural form, as a whole or ground. Thus, e.g., cinnamon is preferably presented as a cinnamon stick or as ground powder from a cinnamon stick. This holds, mutatis mutandis, for other natural aroma generating substances. The skilled person is well aware of these substances, and in which forms these can be conveniently presented. In the context of this invention, the term “aroma generating substance” does not include coffee itself. The invention specifically is directed to the aromatization of coffee with aroma's in addition to the coffee aroma.

Without wishing to be bound by theory, the inventor believes that the aromatization in accordance with the invention takes place as a result of volatile aroma's being present in the environment in which the coffee beans and the aroma-generating substance are held captured. In this respect, a particular advantage of the method according to the invention, is that no liquid or powder carriers are needed, as the aromatizing method does not require any intimate contact between the aroma generating substance and the coffee beans.

According to the invention, capturing an aroma generating substance together with whole or ground coffee beans is intended to allow volatile aroma's to infuse the coffee beans. The beans and the aroma generating substance do not need to be in physical contact with each other. Preferably, they are not in physical contact. If they are stored together, e.g. packaged, in such a way that they could be in physical contact, the aroma generating substance is removed before subjecting the coffee to further processing, and at any rate before brewing. It is noted that the terms “brewing” and “extraction” indicate the same process, viz. subjecting roast and ground coffee beans to contact with hot water or steam, so as to make the extract generally consumed as liquid coffee, or further processed to make a reconstitutable powder (instant coffee).

Apart from the fact that an entirely new method is provided to aromatize coffee beans, it particularly opens up a new way of making aromatized coffee at the stage of the whole bean.

The aroma generating substance preferably is a solid and dry substance. It is further preferred, that the aroma generating substance is provided in such a way as to be separable from the coffee beans. For, it will be understood that the aroma-generating substance is not intended to be subjected to any further processing of the coffee beans with which it is held captured. I.e., in the event of green beans, it is not intended for the aroma-generating substance to be roasted with the green beans. In the event of whole roasted beans, it is not intended for the aroma-generating substance to be ground with the roasted beans. And, in the event of ground roasted beans, it is not intended for the aroma-generating substance to be subjected to the extraction of the roast and ground beans.

It is therefore preferred that the aroma-generating substance and the coffee beans, whole or ground, are held captured in such a way as to be separable. The latter can advantageously be secured by appropriate selection of the aroma-generating substance, viz. by using substances that by their size and/or shape are separable from whole or ground coffee beans. This holds, e.g., in the event of a cinnamon stick or a vanilla stick.

It is preferred, however, to not be limited to aroma-generating substances of any specific shape or size. Particularly, it would be desired to use any powdery form of an aroma-generating substance. In this respect, it is preferred to secure the separability of the aroma-generating substance by providing it in a holding device. Thus, e.g., a cinnamon or vanilla stick can be used as such, but ground substances are preferably held in a removable holding device such as a filter bag, or another container that allows volatiles to disseminate into the environment, and thus reach the coffee beans. As non-limiting examples, a filter bag comparable to filter bags used for tea or herbs can be used, or a perforated foil bag. Alternatively, the holding device may be integrated in the package, e.g. in the form of a separate compartment of a cartridge or in the cover of a jar.

Preferably, the invention provides a method for aromatizing coffee, comprising holding whole or ground coffee beans and at least one aroma generating substance captured into an environment for an effective standing time as to provide aromatized whole or ground coffee beans, and removing the aroma-generating substance before further processing of the aromatized whole or ground coffee beans.

The method of the invention is applicable to coffee beans. In the event of roasted beans, these can be whole beans or ground beans. Surprisingly, whilst the general approach in the art is to aromatize roasted beans by means of intimate physical contact between the beans and an aroma carrier, such as a flavoring agent in liquid or powder form, the inventor has now found that roasted beans (whole beans or ground beans) are capable of taking up volatile aromas when these are generated in the presence of said beans.

Further, even more surprisingly, the inventor has found that also green (i.e. unroasted) coffee beans can be used. Not only have green beans turned out to take up the generated aroma well, it has also been found, and surprisingly so, that these aromas are well preserved during roasting of the beans. Preferably, the invention provides a method for aromatizing coffee, comprising holding green coffee beans and at least one aroma generating substance captured into an environment for an effective standing time, followed by subjecting the green beans to roasting. Thus, the invention provides an advantageous coffee intermediate product, in the form of aromatized green coffee beans.

The sole requirement for the aromatization of the coffee beans, whether roasted or green, to take place, is that the coffee beans and at least one aroma generating substance are captured into an environment for an effective standing time.

The term “captured” refers to the fact that the coffee beans and the aroma generating substance are kept together, or at least in each others vicinity, in such a way that the aroma generated can reach the coffee beans. This will generally mean that the coffee beans and the aroma generating substance are held in a closed environment, such as a package, such as a bag, or a chamber, such as a vessel or a container. It will be understood that “closed” is to be interpreted broadly, i.e. it will not be necessary to prevent any and all leakage of aroma, as long as sufficient aroma will be able to reach the coffee beans. Preferably, though, the capturing takes place in a vapor-tight environment, so as to lose as little as possible of the generated aroma, e.g. in an aluminum bag.

In an interesting embodiment, wherein the solid form of coffee consists of green coffee beans, the beans are captured with the aroma-generating substance in one or more silo's. Such silo's are conventionally used to store green beans before they are roasted and generally comprise a vessel, usually a metal vessel, preferably placed above the roaster.

In an alternative interesting embodiment, the green beans are captured with the aroma-generating substance in bags, usually fabric bags, or containers in which the green beans are normally transported after having been harvested.

It will be understood that each form of solid coffee can have its own specific ways of transport, storage and handling, all determining possibilities for capturing the coffee with an aroma-generating substance. Preferred environments in which the beans and the aroma generating substance are captured, are selected from the group consisting of packages, such as bags, cans, cartridges or jars, e.g. fabric bags, paper bags, foil bags, laminate bags, aluminum bags, metal cans, or chambers such as vessels, silo's, trucks, train wagons, and sea containers. Suitable packages are known to the skilled person.

In further interesting embodiments, e.g., roast and ground coffee can be captured with an aroma-generating substance in a package. This can be a package comprising roast and ground coffee in a loose form, such as generally sold for use in traditional coffee-making equipment such as espresso machines, drip-filter coffeemakers, percolators, and the like. The package can also be a package of so-called coffee pads (or pods), which is a presentation form of roast and ground coffee in a filter bag such as provided for coffeemakers of a specific type, designed to extract such coffee pads. This type of equipment is well known under the “SENSEO®” trademark.

The skilled person will immediately understand that the standing time and the type of capturing environment will be related to each other, as well as the intensity (amount) of the aroma that liberates from the aroma generating substance. Put simply: the larger the environment, the longer the standing time will generally be. Thus, the standing time can vary considerably. Generally, the standing time is at least one day, preferably at least one week. More preferably, the standing time is in a range of from two weeks to three months. It is generally not harmful, however, if a much longer standing time is applied, e.g., one year. This can particularly be the case if the standing time is provided in combination with storage and/or transport of the coffee beans. This can refer to storage of green beans, with the presence of an aroma generating substance being provided in the storage facility, preferably at the coffee manufacturer's premises, where the green beans are received, stored, and then subjected to roasting, such as in the aforementioned silo's. In another interesting embodiment, the coffee beans and the aroma generating substances are captured during transportation. E.g., to a load of green coffee beans kept in a truck, or in a container loaded onto a truck, an amount of aroma generating substance is added before transportation, with the standing time provided during transportation. In the event of container transport, a further standing time can naturally be provided on site, after unloading of the container. This can also be conveniently combined with transport by sea, combined or not with transport by land, particularly if such transport is provided by containers of the type that can be loaded into a ship as well as on a truck. The transportation, with capturing of the coffee beans with an aroma generating substance, can be of green beans but the same holds in the event of transportation of roasted beans. In yet another interesting embodiment, the beans are captured with an aroma generating substance in a package intended for an end-user, including gross-sale packages for commercial end-users or retailers, as well as packages for private consumers. The standing time will then be the time from manufacturing of the package until it is opened, or even until the package is fully used by a consumer. Generally, the standing time will thus be at most equal to the recommended shelf-life of the coffee package, e.g., one year.

The standing temperature is not particularly critical. It is preferred that the temperature is in a range running from above zero to 50° C., preferably from 4° C. to 25° C. Most preferably, room temperature (18° C. to 25° C., preferably 20° C. to 23° C.) is applied.

The relative amounts of the aroma generating substance vis-à-vis the whole or ground coffee beans suitably vary widely. Generally, the weight ratio of aroma generating substance to coffee will range of from 1:10 to 1:100. Preferably, this range is 1:20 to 1:60 and more preferably 1:30 to 1:50.

In an interesting embodiment, the aroma generating substance is added to coffee-beans containing reservoirs or cartridges for use in coffee machines that operate by grinding beans and then extracting liquid coffee. It will be understood, that the aroma generating substance will preferably be provided in such a way that it is not subjected to the subsequent grinding of the coffee. In coffee machines operating on the basis of a reservoir of beans, from which beans are retrieved into a grinding device, e.g. through a funnel, it will be straightforward to provide the aroma generating species in a holding device, such as a filter bag, permeable to volatile aromas placed on top of a charge of coffee beans, and being of a sufficiently large dimension not to be capable of exiting into the direction of the grinder (i.e. too large to pass through the opening of the funnel that is used to transfer coffee beans to the grinder). If the coffee beans are provided in a cartridge, preferably comprising at least two compartments, the aroma generating substance and the coffee beans will best be provided in separate compartments of the cartridge, said compartments being designed in such a way that vapor communication between these compartments is possible, so as to allow volatile aromas to reach the coffee beans. Such communication can be, e.g., by providing a wall between these compartments that is permeable to volatile aromas, such as a membrane, or via openings in the wall, the wall preferably being made of the same material as the cartridge.

In connection with the foregoing, the invention also pertains to a package comprising roasted coffee beans and an aroma generating substance, preferably a dry and solid aroma generating substance. In one preferred embodiment, the package is a paper or foil bag. In another preferred embodiment, the package is a cartridge. Preferably, the cartridge comprises at least two compartments. In a more preferred embodiment, the package is a cartridge comprising a compartment containing the coffee beans and a compartment containing the aroma generating substance, said compartments being connected so as to allow vapor communication from the compartment containing the aroma generating substance to the compartment containing the coffee beans.

The coffee beans used can be of any type. The main coffee species used are Arabica beans and Robusta beans. Typically, mixtures of both can be used. These beans can be recognized as having a specified geographical origin, such as Brazil, Colombia, or Indonesia.

The invention also pertains to a method of making an aromatized coffee. The method of the invention comprises the steps of:
(a) providing roasted coffee beans;
(b) providing an aroma generating substance;
(c) allowing the aroma generating substance to dispense aroma onto the coffee beans so as to provide aromatized roasted coffee beans;
(d) separating the aromatized coffee beans from the aroma generating substance;
(e) subjecting the aromatized roasted coffee beans to grinding so as to provide roast and ground aromatized coffee;
(f) subjecting the roast and ground aromatized coffee to extraction under the influence of hot water or steam so as to provide liquid coffee.

In an alterative embodiment of making an aromatized coffee, the invention provides a method comprising the steps of:
(a) providing green coffee beans;
(b) providing an aroma generating substance;
(c) allowing the aroma generating substance to dispense aroma onto the coffee beans so as to provide aromatized green coffee beans;
(d) separating the aromatized green coffee beans from the aroma generating substance;
(e) subjecting the aromatized green coffee beans to roasting so as to provide aromatized roasted coffee beans;
(f) grinding so as to provide roast and ground aromatized coffee;
(g) subjecting the roast and ground aromatized coffee to extraction under the influence of hot water or steam so as to provide liquid coffee.

The foregoing processes can be conducted on a small scale, using household coffee-making equipment, on a commercial scale, using larger scale coffee equipment as typically used in bars, restaurants, conference centers, and the like. It can also be on industrial scale, e.g., using industrial-type extraction columns.

The invention also pertains to the coffee extract obtained from the aforementioned processes. The extract can be consumed in the form of liquid coffee. It can also be coffee put to use in a subsequent process of making instant coffee. Such processes are well-known, and operate e.g., on the basis of freeze-drying of the liquid coffee obtained. The coffee according to the invention is obtainable by extraction from aromatized ground roasted coffee beans, wherein the coffee is aromatized with aroma from an aroma generating substance, and wherein the extraction takes place substantially in the absence of the aroma generating substance. It will be understood that the invention refers to a specific method by which aroma is provided to coffee, viz. in circumstances wherein only volatiles from the aroma-generating substance (.e. the aroma in a strict sense) are capable of being transferred to the coffee solids. This is an essentially different process than a method wherein the material subjected to extraction by hot water or steam comprises both the coffee solids and an additional (possibly aroma-generating) substance, such as a spice. In the latter case not only aroma (i.e. volatiles) are subjected to extraction, but other constituents of the additional substance that are susceptible to extraction, will be extracted from the coffee solids as well.

The invention will hereinafter be illustrated with reference to the following non-limiting examples.

### Example 1

### Ingredients

Green coffee beans

Dried chamomile flowers

Aluminized bag

Filter paper material

Procedure
An aluminized bag is filled with 1 kg green coffee beans
A filter paper bag is filled with 25 gram of dried chamomile flowers
The filter paper bag is placed on top of the green beans in the aluminized bag
The bag is flushed with Nitrogen and sealed
The bag is stored for 5 weeks
After this storage period the bag is opened and the filter bag with chamomile is taken out
The green coffee beans are roasted and ground
The coffee is brewed using the farmers pot method (pouring hot water on the ground coffee and wait for 15 minutes)

### Example 2

### Ingredients

Roasted coffee beans

Dried chamomile flowers

Aluminized bag

Filter paper material

Procedure
An aluminized bag is filled with 1 kg roasted coffee beans
A filter paper bag is filled with 25 gram of dried chamomile flowers
The filter paper bag is placed on top of the roasted beans in the aluminized bag
The bag is flushed with Nitrogen and sealed
The bag is stored for 5 weeks
After this storage period the bag is opened and the filter bag with chamomile is taken out
The roasted coffee beans are ground
The coffee is brewed using the farmers pot method (pouring hot water on the ground coffee and wait for 15 minutes)

### Example 3

In addition to dried chamomile flowers, a range of other ingredients was used in the same procedures as in Examples 1 and 2. The resulting coffee extracts were tested by a panel for smell and flavor. The ingredients used, and the results obtained, are indicated in Table 1 below. It is noted that the + and − signs indicate the following appreciation:

−− or − flavour is hardly noticeable

0/+ flavour is noticeable

+ or ++ flavour is clearly noticeable

All coffees listed have a noticeable smell or taste difference as compared to standard, non-aromatized coffee.

TABLE 1
(evaluation)

| | Example 1 (green beans) | | Example 2 (roasted beans) | |
|---|---|---|---|---|
| Ingredient | Smell | Taste | Smell | Taste |
| Lavender | ++ | + | ++ | ++ |
| Chamomile | + | − | + | 0/+ |
| Vanilla | + | + | ++ | ++ |
| Cinnamon | − | + | 0/+ | 0/+ |
| Cardamom | − | 0/+ | 0/+ | + |
| Ginger | 0/+ | + | + | ++ |
| 5 spice mix | + | ++ | ++ | + |
| Cloves | + | ++ | ++ | + |
| Pizza | + | ++ | ++ | + |

### Example 4

In this example, different conditions for aroma infusion are tested. The experiment is done on the basis of two aroma generating substances selected for their tendency to be on the extreme side of taste, viz. mild and strong. Chamomile is used as representing the extreme mild taste, and clove is used as reflecting the extreme strong taste.

An amount of 1 kg of coffee beans (100% Arabica) is put in a 5 kg bag, having a width of 25 cm, a length of 60 cm and an extension of 14.5 cm. The applicable roasting conditions are 200° C.-230° C., 11 minutes, Color Value 30-40 in a pilot roaster.

Spices are provided in tea bags, which are kept at the inside of the coffee bag, with the coffee bag closed during a desired infusion period. Chamomile is provided as dried chamomile flowers, clove is provided in a course ground form. Then the tea bags are removed, and the coffee is processed further. For roasted beans this means grinding (disk grinder, particle size (X₅₀)=330-380 μM) and densifying (to a bulk volume of 690-710 cc/250 g). For green beans, these processing steps are preceded, after removal of the tea bag, by roasting (according to the same conditions as above).

The ground, densified coffee is put into L'OR EspressO capsules, containing 5.3 g coffee grinds, and brewed using a Nespresso® Citiz.

A total of 64 samples of capsule espresso is obtained: 32 for each spice. Thereof 16 are based on infusion of green beans and 16 are based on infusion of roasted beans. Of either of these sets, 8 samples are based on storage (infusion) at 4° C. and 8 samples are based on storage (infusion) at 23° C. Half of these samples are based on low concentration of spice (3 wt. % for chamomile, 0.5 wt. % for clove), the other half on a high concentration (10 wt. % for chamomile, 3 wt. % for clove). All of these groups of 4 samples are distinguished by the infusion time, viz. 1 week, 3 weeks, 5 weeks, or 8 weeks.

The samples are tasted by experts, and rated according to a scale from 1 to 5. Therein 1 stands for neutral (reference product, brewed from non-infused coffee grinds). Each value above 1 indicates that infusion with an aroma generating substance is noticeable, running from a mild infused aroma at 1.5, to a strong infused aroma at 5.

The results are grouped in Tables 2 to 5 below. In view of the essential process differences between green beans and roasted beans, these results are not mutually comparable. Without wishing to be bound by theory, the inventors believe that the roasting after infusion provides a greater dominance of roasted coffee taste over infused aroma taste, than in case of first roasting and then conducting the infusion.

From the results below, it is apparent that both an extremely mild aroma generating substance (chamomile)) and a strong aroma generating substance (clove) lead to noticeable infused aroma taste in the range of process conditions tested. This shows the widespread applicability of the invention to a range of aroma generating substances.

The experiment also serves to provide the skilled person with guidance as to how to adapt the process parameters in order to achieve an infused aroma as desired. In the experiment, the parameters adjusted are storage temperature, storage time, and amount of aroma generating substance. The samples with noticeable infused aroma taste have been indicated in bold.

TABLE 2
Chamomile, Green Beans

| Infusion | | | | | |
|---|---|---|---|---|---|
| conditions | Reference | 1 wk | 3 wk | 5 wk | 8 wk |
| 4° C. 3% | 1 | 2 | 2.5 | 2 | 1.5 |
| 4° C. 10% | 1 | 1.5 | 1.5 | 2 | 3 |
| 23° C. 3% | 1 | 1.5 | 2 | 2 | 2 |
| 23° C. 10% | 1 | 1.5 | 2 | 3 | 1.5 |

TABLE 3
Clove, Green Beans

| | Reference | 1 wk | 3 wk | 5 wk | 8 wk |
|---|---|---|---|---|---|
| 4° C. 0.5% | 1 | 1 | 1 | 1 | 1.5 |
| 4° C. 3% | 1 | 1.5 | 2 | 1.5 | 2 |
| 23° C. 0.5% | 1 | 1 | 1.5 | 1.5 | 1 |
| 23° C. 3% | 1 | 1.5 | 1.5 | 1.5 | 2.5 |

TABLE 4
Chamomile, Roasted Beans

| Infusion | | | | | |
|---|---|---|---|---|---|
| conditions | Reference | 1 wk | 3 wk | 5 wk | 8 wk |
| 4° C. 3% | 1 | 2 | 1.5 | 1.5 | 2.5 |
| 4° C. 10% | 1 | 3 | 3.5 | 3.5 | 4 |
| 23° C. 3% | 1 | 2 | 2.5 | 2 | 1.5 |
| 23° C. 10% | 1 | 1.5 | 1.5 | 2 | 3 |

TABLE 5
Clove, Roasted Beans

| | Reference | 1 wk | 3 wk | 5 wk | 8 wk |
|---|---|---|---|---|---|
| 4° C. 0.5% | 1 | 1.5 | 1.5 | 1.5 | 1.5 |
| 4° C. 3% | 1 | 2 | 2 | 2.5 | 3 |
| 23° C. 0.5% | 1 | 2 | 1.5 | 1.5 | 2 |
| 23° C. 3% | 1 | 2 | 3.5 | 4 | 4.5 |

1. A method for aromatizing coffee, comprising holding whole or ground coffee beans and at least one aroma generating substance held captured into an environment for an effective standing time, and removing said substance.

2. A method according to claim 1, wherein the coffee beans are roasted beans.

3. A method according to claim 1, wherein the coffee beans are green coffee beans.

4. A method according to claim 3, followed by subjecting the green beans to roasting.

5. A method according to claim 1, wherein the aroma generating substance is a natural substance selected from the group consisting of spices, herbs, fruits, flowers, and mixtures thereof.

6. A method according to claim 1, wherein the aroma generating substance is a solid and dry substance, preferably held in a holding device, such as a filter bag.

7. A method according to claim 1, wherein the environment in which the whole or ground beans and the aroma generating substance are captured, is selected from the group consisting of packages, such as bags, cans, cartridges or jars, or chambers such as vessels, silo's, trucks, train wagons, and sea containers.

8. A method according to claim 3, wherein green coffee beans and an aroma generating substance are held captured in a fabric bag or a silo.

9. A method according to claim 7, wherein the aroma generating substance is a natural substance selected from the group consisting of spices, herbs, fruits, flowers, and mixtures thereof; wherein the aroma generating substance is a solid and dry substance, preferably held in a holding device, such as a filter bag; and wherein whole or ground roasted coffee beans and an aroma generating substance are held captured in a package.

10. A method according to claim 9, wherein the aroma generating substance is contained in a holding device in the package, permeable to volatile aroma's and from which the whole or ground roasted coffee beans are separable.

11. A method according to claim 10, wherein the package is a cartridge comprising at least two compartments, and the coffee beans and the aroma generating substance are provided in different compartments of said cartridge, the compartment comprising the aroma generating substance being the holding device.

12. A method according to claim 1, wherein the standing time is at least one day, preferably at least one week.

13. Aromatized whole or ground coffee beans obtainable by a method according to claim 1.

14. Aromatized green coffee beans.

15. A package comprising whole or ground roasted coffee beans and an aroma generating substance, wherein the aroma generating substance is present in a removable way, preferably in a separate container.

16. A package according to claim 15, in the form of a cartridge comprising a compartment containing roasted coffee beans and a compartment containing an aroma generating substance, said compartment being connected so as to allow vapor communication from the compartment containing the aroma generating substance to the compartment containing the coffee beans.

17. A package according to claim 15, wherein the aroma generating substance is a natural substance selected from the group consisting of spices, herbs, fruits, flowers, and mixtures thereof.

18. A package according to claim 17, wherein the aroma generating substance is a solid and dry substance.

19. A method of making an aromatized coffee, the method comprising the steps of:
(a) providing roasted coffee beans;
(b) providing an aroma generating substance;
(c) allowing the aroma generating substance to dispense aroma onto the coffee beans so as to provide aromatized roasted coffee beans;
(d) separating the aromatized coffee beans from the aroma generating substance;
(e) subjecting the aromatized roasted coffee beans from step (d) to grinding so as to provide roast and ground aromatized coffee;
(f) subjecting the roast and ground aromatized coffee to extraction under the influence of hot water or steam so as to provide liquid coffee.

20. A method of making an aromatized coffee, the method comprising the steps of:
(a) providing green coffee beans;
(b) providing an aroma generating substance;
(c) allowing the aroma generating substance to dispense aroma onto the coffee beans so as to provide aromatized green coffee beans;
(d) separating the aromatized green coffee beans from the aroma generating substance;
(e) subjecting the aromatized green coffee beans from step (d) to roasting so as to provide aromatized roasted coffee beans;
(f) grinding the aromatized roasted coffee beans so as to provide roast and ground aromatized coffee;
(g) subjecting the roast and ground aromatized coffee to extraction under the influence of hot water or steam so as to provide liquid coffee.

21. Coffee obtainable by extraction from aromatized ground roasted coffee beans, wherein the coffee is aromatized with aroma from an aroma generating substance, and wherein the extraction takes place substantially in the absence of the aroma generating substance.
